(19) United States
(12) Patent Application Publication
(10) Pub. No.: US 2004/0137287 A1
(43) Pub. Date: Jul. 15, 2004

(54) Technique and apparatus to control the power output of a fuel cell stack

(76) Inventors: Richard Cutright, Corinth, NY (US); Jeffrey Ingraham, Albany, NY (US)

Correspondence Address: TROP PRUNER & HU, PC, 8554 KATY FREEWAY, SUITE 100, HOUSTON, TX, 77024, US

(21) Appl. No.: 10/342,149

(22) Filed: Jan. 13, 2003

(51) Int. Cl. H01M 8/04; H01M 8/06

(52) U.S. Cl. 429/13; 429/23; 429/19

(57) ABSTRACT

A technique that is usable with a fuel cell stack includes providing a reactant flow to the fuel cell stack. The output current of the fuel cell stack is regulated to cause an output power from the fuel cell stack to be near a peak output power for the reactant flow being provided to the stack, and the reactant flow to the stack is controlled to regulate the output power from the fuel cell stack near a desired power level.

### BACKGROUND

The invention generally relates to a technique and apparatus to control the power output of a fuel cell stack.

A fuel cell is an electrochemical device that converts chemical energy that is produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following relationships:

H₂→2H⁺+2e⁻ Eq. 1

at the anode of the cell, and

O₂+4H⁺+4e⁻→2H₂O Eq. 2

at the cathode of the cell.

A typical fuel cell has a terminal voltage near one volt DC. For purposes of producing much larger voltages, several fuel cells may be assembled together to form a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A fuel cell system may include a fuel processor that converts a hydrocarbon (natural gas or propane, as examples) into a fuel flow for the fuel cell stack. For purposes of controlling the output power from the fuel cell stack, the fuel processor may be controlled pursuant to a mathematical model. In this manner, the fuel cell system may be characterized by the mathematical model in that the model may be used to derive reactant flows (to the stack) that produce a desired power output for the stack. Based on this model, the reactant flows to the stack are controlled in an attempt to regulate the stack's output power. However, a difficulty with such an arrangement is that many complex sensors may be needed to measure various flow rates and concentrations to accurately model the fuel cell system. Furthermore, the model may not account for various parameters, such as, for example, the degradation of components of the fuel cell system over time.

Thus, there is a continuing need for an arrangement and/or technique to more efficiently regulate the power that is produced by a fuel cell stack.

### SUMMARY

In an embodiment of the invention, a technique that is usable with a fuel cell stack includes communicating power from the stack to a load and providing a reactant flow to the fuel cell stack. The output current of the fuel cell stack is regulated to cause an output power from the fuel cell stack to be near a peak output power for the reactant flow being provided to the stack, and the reactant flow to the stack is controlled to regulate the output power from the fuel cell stack near a desired power level.

Advantages and other features of the invention will become apparent from the following description, drawing and claims.

### BRIEF DESCRIPTION OF THE DRAWING

FIG. 1 is a schematic of a fuel cell system according to an embodiment of the invention.

FIG. 2 depicts polarization curves for a fuel cell stack of the system of FIG. 1 for different reactant flows.

FIGS. 3, 4, and 5 are flow diagrams depicting operation of the fuel cell system according to an embodiment of the invention.

### DETAILED DESCRIPTION

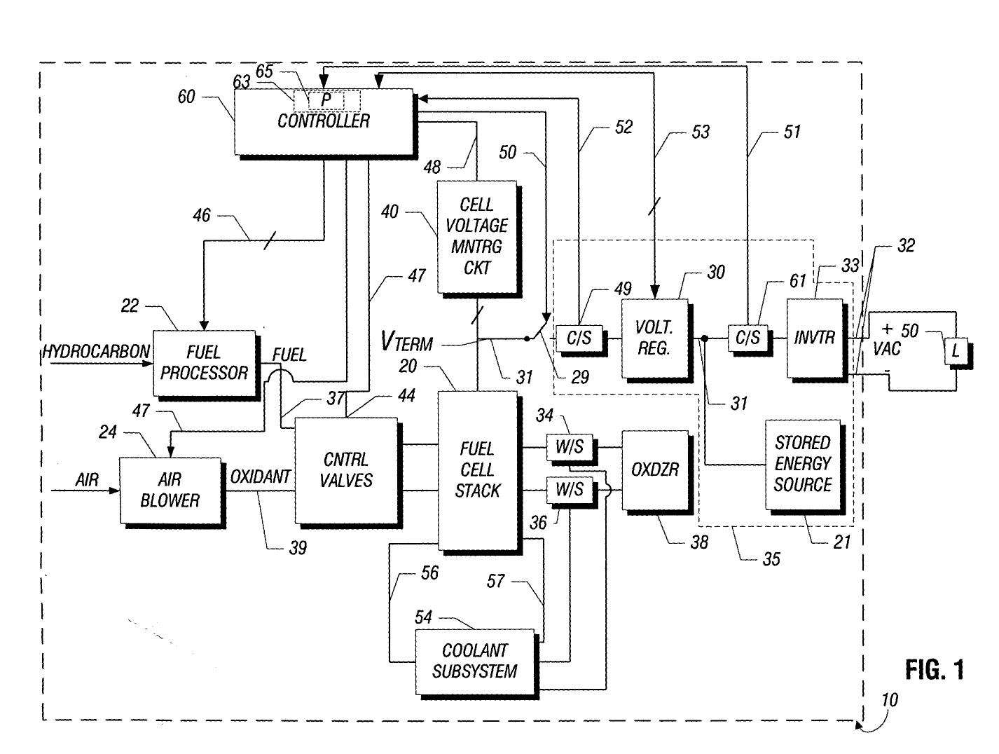

Referring to FIG. 1, an embodiment of a fuel cell system 10 in accordance with the invention includes a fuel cell stack 20 that is capable of producing power for a load 50 (a residential load, for example) in response to fuel and oxidant (i.e., reactant) flows that are provided by a fuel processor 22 (a reformer, for example) and an air blower 24, respectively. In this manner, the fuel cell system 10 controls the fuel production of the fuel processor 22 to control the fuel flow that the processor 22 provides to the fuel cell stack 20. This rate of fuel flow to the fuel cell stack 20, in turn, controls the level of power that is produced by the stack 20. The fuel cell system 10 also controls the air flow from the air blower 24 to regulate the appropriate stoichiometric ratio (see Eqs. 1 and 2 above) of reactants flowing to the fuel cell stack 20.

As described below, instead of using a model to control the fuel processor 22 to regulate the output power of the fuel cell stack 20 near a desired power level, the fuel cell system 10 uses a less complicated control scheme. In particular, the fuel cell system 10 generally uses two different control loops to control the output power of the fuel cell stack 20: a first loop to optimize the power that the fuel cell stack 20 produces for a given fuel flow rate to the stack 20; and a second loop to control the fuel flow to the fuel cell stack 20 for purposes of regulating the output power from the fuel cell stack 20 near a desired level. As a result of this control technique, the fuel cell system 10 maximizes the output power of the fuel cell stack 20 for a given flow of fuel to the stack 20 in a direct manner that does not require sensing the number of parameters required in a conventional model-based control technique.

The optimization of the power that is output from the fuel cell stack 20 is based on the recognition that for a given reactant fuel flow, the performance of a fuel cell stack that receives the flow may be represented by a plot of the output power of the fuel cell stack versus the output current from the stack. This plot is referred to herein as a “power curve” for the fuel cell stack. The power curve relationship is attributable to many different factors, such as the cell construction of the stack, the catalyst condition and various operating conditions (temperature, pressure, gas concentrations, poisons, humidity, reactant flow rates, etc.).

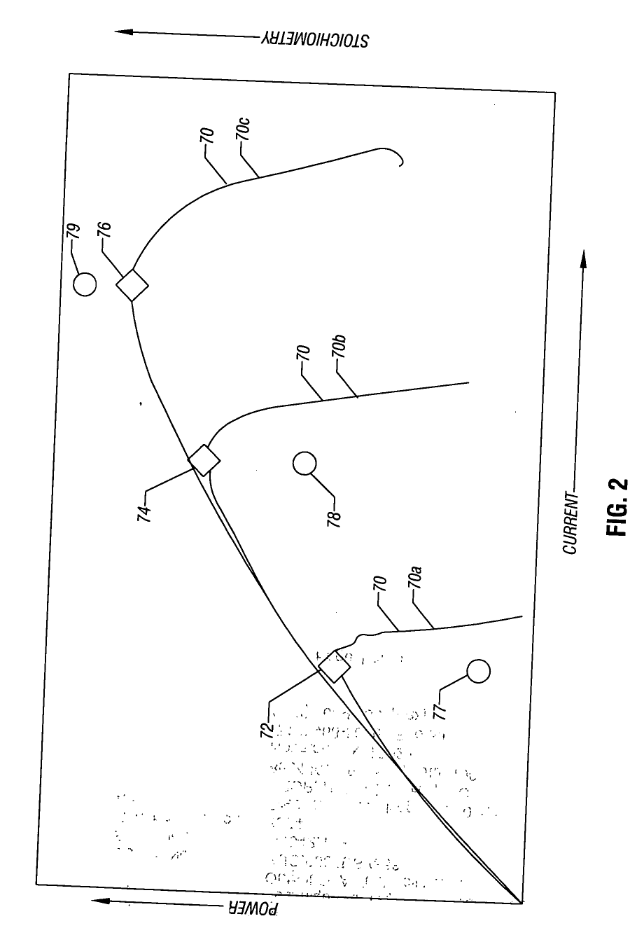

FIG. 2 depicts three such power curves 70 (power curves 70a, 70b and 70c) for the fuel cell stack 20, each of which is associated with a different rate of fuel flow to the stack 20. In this manner, the power curve 70a represents the output power of the fuel cell stack 20 for a relatively low flow of fuel to the stack 20. The power curve 70b represents the output power of the fuel cell stack 20 for a higher, medium flow of fuel to the stack 20, and the power curve 70c represents the output power of the fuel cell stack 20 for an even higher flow of fuel to the stack 20. As depicted by each power curve 70, the power that is furnished by the fuel cell stack 20 increases until the power reaches a peak, i.e., the maximum point of the curve 70. Power curves 70a, 70b and 70c have peaks 72, 74 and 76, respectively. Thus, as can be seen from FIG. 2, the larger the fuel flow, the higher the potential peak power that is provided by the fuel cell stack 20.

As depicted in FIG. 2, for a particular power curve 70, the power that is provided by the fuel cell stack 20 increases with an increase in the current that is provided by the stack 20 until the peak power point is reached. However, after the peak output power from the fuel cell stack 20 has been reached, the output power decreases with an increase in the current from the stack 20. Thus, by regulating the current from the fuel cell stack 20 near the peak of the corresponding power curve 70, the maximum output power for the stack 20 for a given fuel flow may be obtained.

Also depicted in FIG. 2 are stoichiometry points 77, 78 and 79 that represent the stoichiometries that may be used in connection with the power curves 70a, 70b, and 70c, respectively. Ideally, the stoichiometry should not be varied with the reactant flow rate. However, an increase in stoichiometry with an increase in fuel flow may be attributable to inefficiencies in the transport of reactants to the catalyst sites for reactions, diffusion rates, mass transport limits, etc.

Thus, the first control loop maximizes (or at least attempts to maximize) the output power of the fuel cell stack 20 for a given reactant flow.

The reactant flow to the fuel cell stack is not constant over time because the desired power output from the fuel cell stack may vary over time. In this manner, the power that is demanded by the load 50 varies over time. This variation in power demand is attributable to the nature of the load 50. For example, the load 50 may represent a collection of individual loads (appliances and/or electrical devices that are associated with a house, for example) that may each be turned on and off. As a result, the power that is consumed or demanded by the load 50 may continually change.

The change in the power that is demanded by the load 50 may result in a corresponding change in the desired stack output power. In this manner, as described below, the output terminals of the fuel cell stack 20 may be coupled to a stored energy source 21 (a battery, for example) for purposes of dampening potential transient power conditions. For example, when the fuel cell stack 20 produces more power than is demanded by the load 50, the excess power charges the energy source 21. Likewise, when the fuel cell stack 20 produces less power than is demanded by the load 50, the energy source 21 furnishes power to the load 50 (i.e., discharges) to supplement the power that the fuel cell stack 20 provides. Thus, an increase in the power that is demanded by the load 50 may result in an increase in the desired power level for the stack 20, depending on the charge storage state of the energy source 21, the duration of the increased power demand from the load 50, etc. A decrease in the power that is demanded by the load 50 may result in an decrease in the desired power level for the stack 20, depending on whether the energy source 21 needs to be charged, the duration of the decreased power demand from the load 50, etc.

Various other potential factors may influence whether the desired power level from the fuel cell stack 20 should be increased or decreased. For example, the fuel cell system 10 may be a combined power and heat generation system. In this manner, heat from the fuel cell stack 20 may be used to heat warm in a water tank, for example. Thus, the desired power level from the fuel cell stack 20 may change depending on the temperature of water in the tank. As another example, the fuel cell system 10 may provide power to a power grid in addition to the load 50. Therefore, the power output from the fuel cell stack 20 may be controlled to regulate the power that the system 10 provides to the power grid based on the time of day, power demanded by the load 50, etc. Thus, there are many different factors that may cause a change in the desired power level from the fuel cell stack 20.

For purposes of accommodating changes in the desired power level from the fuel cell stack 20, the second control loop regulates the fuel flow to the stack 20 for purposes of achieving this desired power level. Therefore, with the use of the two control loops, the stack output power is ideally at the peak of the power curve that is associated with the current reactant flow to the stack 20.

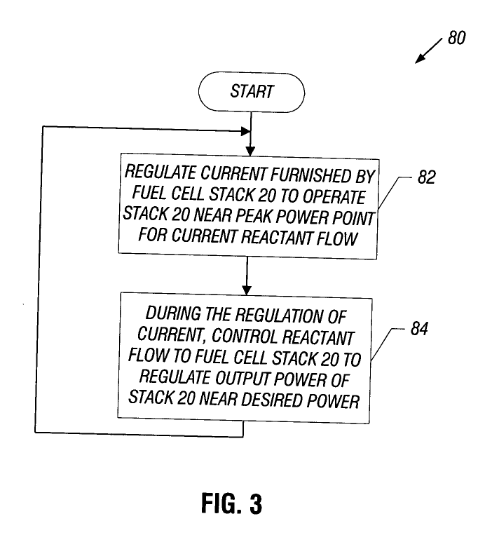

Referring back to FIG. 1, in some embodiments of the invention, the fuel cell system 10 includes a controller 60 that executes program instructions 65 that are stored in a memory 63 (of the system 10). These program instructions cause the controller 60 to perform one or more routines that are related to the first and second control loops. More specifically, in some embodiments of the invention, the program instructions 65 cause the controller 60 to perform a technique 80 that is depicted in FIG. 3.

Referring to FIG. 3, in the technique 80, the controller 60 regulates (block 82) the current that is furnished by the fuel cell stack 20 to operate the stack 20 near the peak power for the fuel flow that is currently being furnished to the stack 20. Concurrently with the regulation of the fuel cell stack's current, the controller 60 regulates (block 84) the reactant flow to the fuel cell stack 20 to control the stack output power near the desired power level.

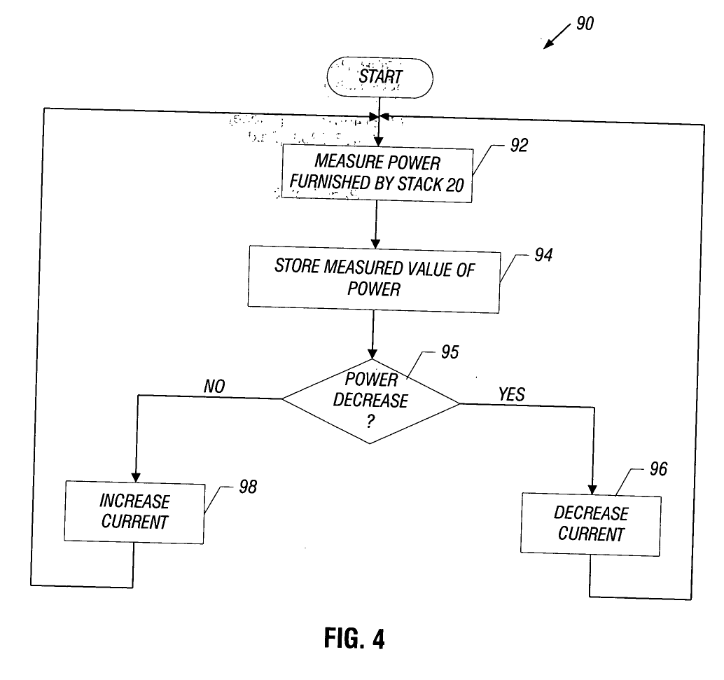

More specifically, in some embodiments of the invention, the program instructions 65, when executed by the controller 60, cause the controller 60 to perform a technique 90 (FIG. 4) to regulate the current from the fuel cell stack 20. The technique 90 is an example of one out of possible many different techniques to adjust the stack current to optimize the stack's output power. In the technique 90, the controller 60 downwardly and upwardly adjusts the current from the fuel cell stack 20, as appropriate, for purposes of locating the peak output power from the stack 20 for the current reactant flow to the stack 20. The technique 90 is an iterative process in which the controller 60 changes the current, determines the effect of the change and makes the next change accordingly.

More particularly, in the technique 90, the controller 60 measures (block 92) the power that is furnished by the stack 20 and stores (block 94) a copy of a valve indicative of this measured power. Next, by comparing the latest power measurement to a previous power measurement, the controller 60 determines (diamond 95) whether the latest change in current produced a decrease in the power that is furnished by the fuel cell stack 20. If so, the power that is furnished by the fuel cell stack 20 is on a point on the associated power curve beyond the peak output power; and in response to this condition, the controller 60 decreases (block 96) the current from the fuel cell stack 20 for purposes of maximizing the stack's output power. Otherwise, if the stack output power has increased, the controller 60 increases (block 98) the stack current. Regardless of whether the current was increased or decreased by the controller 60, control returns to block 92.

In some embodiments of the invention, the controller 60 cycles through the technique 90 at a predetermined frequency, such as a frequency in the range of about one hundred hertz (Hz) to one kilohertz (KHz), as an example. The technique may be associated with other control frequencies, in other embodiments of the invention.

Many different techniques and subsystems may be used to increase and decrease the current that is provided by the fuel cell stack 20. One such subsystem/technique is described below.

Referring back to FIG. 1, in some embodiments of the invention, the controller 60 regulates the current that is provided by the fuel cell stack 20 by controlling the input impedance of power conditioning circuitry 35 of the fuel cell system 10. The power conditioning circuitry 35 is coupled between the terminals of the fuel cell stack 20 and the load 50. Thus, DC voltage output terminals 31 of the fuel cell stack 20 are coupled to the input terminals of the power conditioning circuitry 35. The DC terminal output voltage (called “V_{TERM}”) of the fuel cell stack 20 is relatively constant. Therefore, by controlling the input impedance of the power conditioning circuitry 35, the controller 60 effectively controls the current that is provided by the fuel cell stack 20 through its output terminals 31.

In general, the power conditioning circuitry 35 dampens transient load conditions as seen from the stack 20 and converts the V_{TERM} voltage from the stack 20 into a regulated AC voltage (called “V_{AC}”) that is received by the load 50. More specifically, in some embodiments of the invention, the power conditioning circuitry includes a DC-to-DC voltage regulator 30, the stored energy source 21 (a battery, for example) and an inverter 33. The voltage regulator 30 is coupled to the output terminals 27 of the fuel cell stack 20 to receive the V_{TERM} stack voltage. The voltage regulator 30 converts the V_{TERM} stack voltage into a regulated output voltage that appears on an output terminal 31 of the regulator 30. The stored energy source 21 is coupled to the output terminal 31 of the regulator 30. An input terminal of a DC-to-AC inverter 33 is coupled to the output terminal 31. The inverter 33 converts the DC voltage that appears on the output terminal 31 into the regulated V_{AC} voltage that is furnished across output terminals 32 of the inverter 33 to the load 50.

The power conditioning circuitry 35, in some embodiments of the invention, provides indications of various parameters to the controller 60, including, for example, the stack current, the V_{TERM} stack voltage, the current in the load 50, etc. For example, the power conditioning circuitry 35 may provide an indication of the stack current to the controller 60 via a current sensor 49 that is coupled in series with an input terminal of the voltage regulator. In this manner, the current sensor 49 furnishes a signal indicative of the stack current to a communication line 52 that is coupled to the controller 60. The controller 60 may use this indication as, for example, feedback to regulate the input impedance of the power conditioning circuitry 35 so that the desired stack current is achieved.

As another example of parameters that the power conditioning circuitry 35 may indicate to the controller 60, the power conditioning circuitry 35 may provide an indication of the current in the load 50 via a current sensor 61 that is coupled in series with an input terminal of the inverter 33. In this manner, the current sensor 61 furnishes a signal indicative of the load current to a communication line 51 that is coupled to the controller 60. As another example, the power conditioning circuitry 35 may provide an indication of the V_{TERM} stack voltage to the controller 60 via a communication line 25. Various other and different parameters may be communicated between the power conditioning circuitry 35 and the controller 60.

In some embodiments of the invention, the controller 60 controls the input impedance of the power conditioning circuitry 35 by controlling the input impedance of the voltage regulator 30. As an example, in some embodiments of the invention, the voltage regulator 30 may be a switching regulator, and the controller 60 may communicate with the voltage regulator 30 to control the regulator's input impedance via one or more control communication lines 53. For example, the controller 60 may use the communication line(s) 53 to regulate the switching frequency of the voltage regulator 30 and/or regulate the duty cycle of the voltage regulator 30 for purposes of controlling the regulator's (and the power conditioning circuitry's) input impedance. Thus, by modifying the duty cycle and/or switching frequency of the voltage regulator 30, the controller 60 adjusts the stack current, in some embodiments of the invention. Therefore, to increase the current from the fuel cell stack 20, the controller 60 interacts with the voltage regulator 30 to lower the regulator's input impedance, and to decrease the current from the fuel cell stack 20, the controller 60 interacts with the voltage regulator 30 to increase the regulator's input impedance.

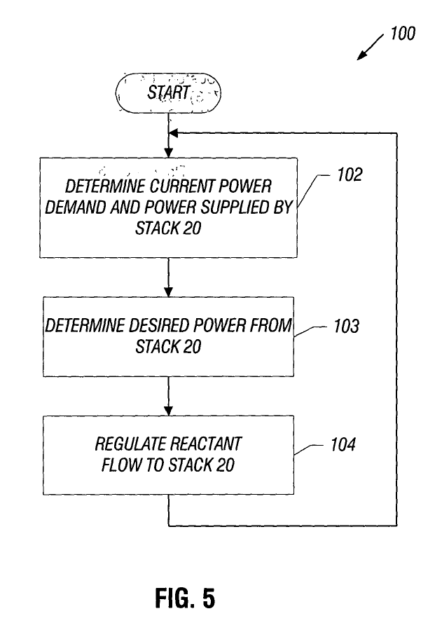

Referring to FIG. 5, in some embodiments of the invention, the controller 60 executes the program instructions 65 to perform a technique 100 to regulate the fuel flow to the fuel cell stack 20 to control the fuel flow to the stack 20. It is noted that the technique 100 is one of many possible techniques to control the fuel flow to the stack 20.

Pursuant to this technique 100, the controller 60 determines the desired power level or the fuel cell stack 20. As an example, in some embodiments of the invention, the controller 60 makes this determination by determining (block 102) the current power that is demanded by the load 50 and the current power that is being furnished by the fuel cell stack 20. In this manner, if the load 50 is demanding more power than is being supplied by the fuel cell stack 20, the controller 60 may increase the desired power level. If the load 50 is demanding less power than is being supplied by the fuel cell stack 20, the controller 60 may decrease the desired power level. In some embodiments of the invention, the controller 60 may use a rolling average when ascertaining the power that is demanded by the load 50 to prevent the controller 60 from prematurely responding to brief load transients. Thus, based on the results from block 102, the controller 60 determines (block 103) the desired power from the stack 20. In response to the desired power output for the stack 20, the controller 60 regulates (block 104 of FIG. 5) the reactant flow to the fuel cell stack 20.

Referring back to FIG. 1, among the other features of the fuel cell system 10, the system 10 may include a cell voltage monitoring circuit 40 that provides indications of individual cell voltages to the controller 60 via a serial bus 48. The fuel cell system 10 may also include a switch 29 that is controlled by the controller 60 (via a communication line 50) for purposes of isolating the fuel cell stack 20 from the power conditioning circuitry 35 in response to a shut down of the fuel cell stack 20. The fuel cell system 10 may also include control valves 44 that provide emergency shutoff of the oxidant and fuel flows to the fuel cell stack 20. The control valves 44 are coupled between inlet fuel 37 and oxidant 39 lines and the fuel and oxidant manifold inlets, respectively, to the fuel cell stack 20. The inlet fuel line 37 receives the fuel flow from the fuel processor 22, and the inlet oxidant line 39 receives the oxidant flow from the air blower 24. The fuel processor 22 receives a hydrocarbon (natural gas or propane, as examples) and converts this hydrocarbon into the fuel flow (a hydrogen flow, for example) that is provided to the fuel cell stack 20.

The fuel cell system 10 may include water separators, such as water separators 34 and 36, to recover water from the outlet and/or inlet fuel and oxidant ports of the stack 22. The water that is collected by the water separators 34 and 36 may be routed to a water tank (not shown) of a coolant subsystem 54 of the fuel cell system 10. The coolant subsystem 54 circulates a coolant (de-ionized water, for example) through the fuel cell stack 20 to regulate the operating temperature of the stack 20. The fuel cell system 10 may also include an oxidizer 38 to burn any fuel from the stack 22 that is not consumed in the fuel cell reactions.

In some embodiments of the invention, the controller 60 may include a microcontroller and/or a microprocessor to perform one or more of the techniques that are described herein when executing the program 65. For example, the controller 60 may include a microcontroller that includes a read only memory (ROM) that serves as the memory 63 and a storage medium to store instructions for the program 65. Other types of storage mediums may be used to store instructions of the program 65. Various analog and digital external pins of the microcontroller may be used to establish communication over the electrical communication lines, such as electrical communication lines 25, 46, 47, 50, 51, 52 and 53 and the serial bus 48. Electrical interferences (not shown) may be coupled between these lines and the controller 60. In other embodiments of the invention, a memory that is fabricated on a separate die from the microcontroller may be used as the memory 63 and store instructions for the program 65. Other variations are possible.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
providing a reactant flow to the fuel cell stack;
regulating a current of the fuel cell stack to cause an output power from the fuel cell stack to be near a peak output power for the reactant flow being provided to the stack; and
controlling the reactant flow to regulate the output power from the fuel cell stack near a desired power level.

2. The method of claim 1, wherein the regulation of the current occurs during the control of the reactant flow.

3. The method of claim 1, wherein the regulating the current comprises:
selectively increasing and decreasing the output current.

4. The method of claim 1, wherein the controlling the reactant flow comprises:
regulating the operation of a fuel processor.

5. The method of claim 4, wherein the fuel processor comprises a reformer.

6. The method of claim 1, further comprising:
determining the desired power level in response to power demanded by a load.

7. The method of claim 1, wherein the regulating the current comprises:
controlling an input impedance of power conditioning circuitry that is coupled.

8. The method of claim 1, wherein the regulating the current comprises:
regulating an input impedance of a voltage regulation that is coupled to a terminal of the fuel cell stack.

9. The method of claim 1, wherein the regulating the reactant flow comprises:
determining the output power from the fuel cell stack.

10. A fuel cell system comprising:
a fuel processor to provide a reactant flow to the fuel cell stack;
power conditioning circuitry to communicated power from the fuel cell stack to a load; and
a controller coupled to the power conditioning circuitry and the fuel processor to:
regulate a current of the fuel cell stack to cause the power from the fuel cell stack to be near a peak output power for the reactant flow being provided to the stack, and
control the reactant flow to regulate the output power from the fuel cell stack.

11. The fuel cell system of claim 10, wherein the controller is adapted to regulate the current during the regulation of the reactant flow.

12. The fuel cell system of claim 10, wherein the controller is adapted to selectively increase and decrease the current of the fuel cell stack to regulate the current.

13. The fuel cell system of claim 10, further comprising:
a fuel processor to provide the reactant flow.

14. The fuel cell system of claim 13, wherein the fuel processor comprises a reformer.

15. The fuel cell system of claim 10, wherein the controller 60 is adapted to deliver the desired power level in response to power demanded by the load.

16. The fuel cell system of claim 10, wherein the controller is adapted to regulate an input impedance of the power conditioning circuitry to control the current.

17. The fuel cell system of claim 10, further comprising:
a voltage regulator to regulate a terminal voltage provided the fuel cell stack,
wherein the controller is adapted to regulate an input impedance of the voltage regulator to control the current.

18. The fuel cell system of claim 10, wherein the controller determines the power from the fuel cell stack to regulate the output current of the fuel cell stack.
